(19) United States
(12) Patent Application Publication
(10) Pub. No.: US 2026/0015036 A1
(43) Pub. Date: Jan. 15, 2026

(54) COIL DESIGN FOR INDUCTIVE SENSOR SYSTEM COMPRISING INDUCTIVE TORQUE AND POSITION SENSOR ASSEMBLIES

(71) Applicant: HL MANDO CORPORATION, Gyeonggi-do (KR)

(72) Inventors: Md Sariful ISLAM, Auburn, MI (US); Mohammad ISLAM, Auburn, MI (US)

(21) Appl. No.: 19/256,288

(22) Filed: Jul. 1, 2025

Related U.S. Application Data
(60) Provisional application No. 63/670,104, filed on Jul. 11, 2024.

(51) Int. Cl. B62D 6/10; G01L 3/10

(52) U.S. Cl. CPC B62D 6/10; G01L 3/105

(57) ABSTRACT

An inductive sensor system includes: a circuit board having coil sets. The coil sets include: a first transmitter coil set having a first main transmitter coil and a first transmitter bias coil; a first receiver coil set having a first main receiver coil and a first receiver bias coil; a second transmitter coil set having a second main transmitter coil and a second transmitter bias coil; and a second receiver coil set having a second main receiver coil and a second receiver bias coil. The circuit board further includes: a first electronic control unit (ECU) associated with the first transmitter coil set and the first receiver coil set; and a second ECU that is separate from the first ECU, the second ECU being associated with the second transmitter coil set and the second receiver coil set.

### CROSS REFERENCE TO RELATED APPLICATIONS

This application claims the benefit from and the priority to U.S. Patent Application Ser. No. 63/670,104, filed on Jul. 11, 2024, titled “REDUNDANT COIL ARCHITECTURE FOR DIFFERENTIAL INDUCTIVE TORQUE SENSOR”, which is hereby incorporated herein by reference in its entirety.

### BACKGROUND

The present disclosure generally relates to an inductive sensor system including inductive torque and position sensor assemblies. More specifically, some embodiments of the present disclosure relate to inductive torque and position sensor assemblies for a steering system of a vehicle by using electromagnetic principles such as inductance to determine torque applied to a steering wheel and a position of a steering shaft.

A steering system used in an automotive vehicle typically includes an input shaft connected to a steering wheel. The input shaft is then connected to an output shaft through a torsion bar and the output shaft, in turn, is mechanically connected through linkage to vehicle wheels. Consequently, the rotation of the steering wheel pivots the wheels of the automotive vehicle through the input shaft, torsion bar, output shaft, and steering linkage.

In many situations, it is highly desirable to determine the angular position of the input or output shaft and the angular deflection between the input shaft and the output shaft of the steering mechanism. The angular position of the input shaft may indicate where a driver wants to steer, matching the steering wheel with the vehicle wheels. And, the degree of angular deflection between the input shaft and the output shaft, i.e. the angular deflection of the torsion bar, is then utilized by a controller to detect the applied steering wheel torque and then to determine the appropriate amount of assist provided by the power steering for the vehicle.

In addition, there has been a recent trend towards electronically controlled steering systems, for instance, a steer-by-wire system which does not have a mechanical linkage between the steering wheel and the vehicle wheels. In the steer-by-wire system, the absolute position of the input shaft and the torque applied to the steering wheel can be used to electrically control the vehicle wheels.

### SUMMARY

The features and advantages of the present disclosure will be more readily understood and apparent from the following detailed description, which should be read in conjunction with the accompanying drawings, and from the claims which are appended to the end of the detailed description.

According to some embodiments of the present disclosure, an inductive sensor system may comprise: an upper rotor comprising an upper target having a first metallic pattern; a lower rotor comprising a lower target having a second metallic pattern; and a stationary circuit board positioned between the upper rotor and the lower rotor, the circuit board comprising: one or more transmitter coil sets configured to generate electromagnetic field, one or more receiver coil sets for sensing relative angular displacement movement between the upper rotor and the lower rotor, wherein the one or more transmitter coil sets and the one or more receiver coil sets are circularly wound.

The one or more circularly wound receiver coil sets for sensing the relative angular displacement movement between the upper rotor and the lower rotor may be positioned radially outside the first metallic pattern of the upper target and the second metallic pattern of the lower target, and the one or more circularly wound transmitter coil sets may be positioned radially inside the first metallic pattern of the upper target and the second metallic pattern of the lower target.

The one or more circularly wound receiver coil sets for sensing the relative angular displacement movement between the upper rotor and the lower rotor may be positioned radially inside the first metallic pattern of the upper target and the second metallic pattern of the lower target, and the one or more circularly wound transmitter coil sets may be positioned radially inside the first metallic pattern of the upper target and the second metallic pattern of the lower target.

At least one of the one or more circularly wound receiver coil sets for sensing the relative angular displacement movement between the upper rotor and the lower rotor may be positioned radially outside the first metallic pattern of the upper target and the second metallic pattern of the lower target, and another or other of the one or more circularly wound receiver coil sets for sensing the relative angular displacement movement between the upper rotor and the lower rotor may be positioned radially inside the first metallic pattern of the upper target and the second metallic pattern of the lower target, and the one or more circularly wound transmitter coil sets may be positioned radially inside the first metallic pattern of the upper target and the second metallic pattern of the lower target, respectively.

The circuit board may comprise an other upper receiver coil set for sensing an angular position of the upper rotor.

The circuit board may comprise an other lower receiver coil set for sensing an angular position of the lower rotor.

The inductive sensor system may further comprise: an auxiliary rotor rotatably engaged with the upper rotor and having a third metallic pattern; and an auxiliary transmitter coil set and an auxiliary receiver coil set included in the circuit board or disposed on an upper surface of the circuit board.

The inductive sensor system may further comprise: an auxiliary rotor rotatably engaged with the lower rotor and having a third metallic pattern; and an auxiliary transmitter coil set and an auxiliary receiver coil set included in the circuit board or disposed on an lower surface of the circuit board.

The inductive sensor system may further comprise: an auxiliary rotor rotatably engaged with the upper or lower rotor and having magnetic material; and a sensor configured to sense magnetic field and positioned below or above the auxiliary rotor.

The upper receiver coil set and the other upper receiver coil set may be disposed on an upper surface of the printed circuit board, the lower receiver coil and the other lower receiver coil set may be disposed on a lower surface of the printed circuit board, and the one or more transmitter coil sets may be disposed on the upper surface of the circuit board, the lower surface of the circuit board, or inside the circuit board.

The circuit board may have multiple layers including upper layers and lower layers, the upper receiver coil set, and the other upper receiver coil set may be disposed on or between the upper layers of the circuit board, the lower receiver coil set, and the other lower receiver coil set may be disposed on or between the lower layers of the circuit board, and the one or more transmitter coil sets may be disposed on the upper or lower surface of the circuit board or between the upper surface and the lower surface of the circuit board.

The first metallic pattern of the first target and/or the second metallic pattern of the second target may have a plurality of circumferentially adjacent lobes.

The third metallic pattern of the second upper rotor may have a substantially half circular or polygonal shape.

The third metallic pattern of the second upper rotor may have a substantially half circular or polygonal shape.

The upper rotor and the auxiliary rotor may have gear teeth to be engaged with each other.

The lower rotor and the auxiliary rotor may have gear teeth to be engaged with each other.

A gear ratio between the upper rotor and the auxiliary rotor may be around from 1.8 to 2.7.

The upper rotor may be comprised in or coupled to an upper shaft coupled to a steering wheel, the lower rotor may be comprised in or coupled to a lower shaft, and a torsion bar may be coupled between the upper shaft and the lower shaft.

According to certain embodiments of the present disclosure, an inductive sensor system may comprise: an upper rotor comprising an upper target having a first metallic pattern; a lower rotor comprising a lower target having a second metallic pattern; an auxiliary rotor rotatably engaged with the upper rotor or the lower rotor; and a stationary circuit board positioned between the upper rotor and the lower rotor, the circuit board comprising: one or more transmitter coil sets configured to generate electromagnetic field, one or more receiver coil sets for sensing relative angular displacement movement between the upper rotor and the lower rotor, and one or more receiver coil sets for sensing an angular position of the upper rotor and/or the lower rotor, wherein: the one or more transmitter coil sets and the one or more receiver coil sets for sensing the relative angular displacement movement between the upper rotor and the lower rotor are circularly wound.

The auxiliary rotor has a third metallic pattern, and an auxiliary transmitter coil set and an auxiliary receiver coil set included in the circuit board or disposed on a surface of the circuit board.

The inductive sensor system may further comprise a sensor configured to sense magnetic field and positioned below or above the auxiliary rotor, wherein the auxiliary rotor rotatably engaged with the upper or lower rotor includes magnetic material.

According to some embodiments of the present disclosure, an inductive sensor system may comprise: a circuit board that comprises coil sets. The coil sets may comprise: a first transmitter coil set comprising a first main transmitter coil and a first transmitter bias coil; a first receiver coil set comprising a first main receiver coil and a first receiver bias coil; a second transmitter coil set comprising a second main transmitter coil and a second transmitter bias coil; and a second receiver coil set comprising a second main receiver coil and a second receiver bias coil. Wherein the circuit board may further comprise: a first electronic control unit (ECU) associated with the first transmitter coil set and the first receiver coil set; and a second ECU that is separate from the first ECU, the second ECU being associated with the second transmitter coil set and the second receiver coil set.

The coil sets are circularly wound coils.

The second main transmitter coil is positioned radially between the outer diameter and the inner diameter of the upper target and the lower target.

The inductive sensor system may further comprise: an upper rotor comprising an upper target having a first metallic pattern; and a lower rotor comprising a lower target having a second metallic pattern, wherein the first main transmitter coil is positioned radially between an outer diameter and an inner diameter of both of the upper target and lower target.

The first transmitter bias coil, the first receiver coil set, the second transmitter bias coil, and the second receiver coil set are positioned radially outside of the outer diameter of both of the upper target and the lower target.

The first transmitter bias coil and the first receiver coil set are positioned radially inside of the inner diameter of both of the upper target and the lower target while the second transmitter bias coil and the second receiver coil set are positioned radially outside of the outer diameter of both of the upper target and the lower target.

The first transmitter bias coil and the first receiver coil set are positioned radially outside of the outer diameter of both of the upper target and the lower target while the second transmitter bias coil and the second receiver coil set are positioned radially inside of the inner diameter of both of the upper target and the lower target.

The first transmitter bias coil, the first receiver coil set, the second transmitter bias coil, and the second receiver coil set are positioned radially inside of the inner diameter of both of the upper target and the lower target.

The first transmitter coil set is configured as a single coil comprising a first portion as the first main transmitter coil and a second portion as the first transmitter bias coil.

The first transmitter coil set comprises a first coil as the first main transmitter coil that is separate from a second coil as the first transmitter bias coil, the first coil being electrically connected to the second coil.

Each of the coil sets comprises a single coil comprising at least two portions that respectively make up a main portion and a bias portion of the single coil.

Each of the coil sets comprises at least two separate coils that are connected to one another, and each of the at least two separate coils being a main portion and a bias portion, respectively, of each of the coil sets.

At least one of the first transmitter coil set or the second transmitter coil set further comprises a compensation coil.

The compensation coil is radially positioned proximate to a main coil of the first transmitter coil set or the second transmitter coil set to which the compensation coil belongs, and the main coil of the first transmitter coil set or the second transmitter coil set to which the compensation coil belongs is the first main transmitter coil or the second main transmitter coil, respectively.

The compensation coil and the main coil of the first transmitter coil set or the second transmitter coil set to which the compensation coil belongs are arranged such that a first current flow within the compensation coil is in a direction opposite to a second current flow within the main coil.

The compensation coil and a bias coil of the first transmitter coil set or the second transmitter coil set to which the compensation coil belongs are arranged such that the first current flow within the compensation coil is in the direction opposite to third current flow within the bias coil, the bias coil of the first transmitter coil set or the second transmitter coil set to which the compensation coil belongs is the first transmitter bias coil or the second transmitter bias coil, respectively, and the bias coil and the main coil of the first transmitter coil set or the second transmitter coil set to which the compensation coil belongs are arranged such that the third current flow is in a same direction as the second current flow.

For the first transmitter coil set or the second transmitter coil set to which the compensation coil belongs: the compensation coil, the main coil, and the bias coil are formed as separate portions of a single coil.

For the first transmitter coil set or the second transmitter coil set to which the compensation coil belongs: the compensation coil, the main coil, and the bias coil are formed as separate coils.

The compensation coil of the first transmitter coil set comprises a first diameter that is smaller than a second diameter of the first main transmitter coil, the first transmitter bias coil comprises a third diameter larger than the second diameter, and the compensation coil of the first transmitter coil set is radially positioned within at least 2 mm of the first main transmitter coil while the first main transmitter coil is radially positioned within at least 5 mm of the first transmitter bias coil.

According to some embodiments of the present disclosure, an inductive sensor system may comprise: a circuit board that comprises a redundant coil set structure configured to reduce mutual coupling between coils making up the redundant coil set structure. The redundant coil set structure may comprise: a first transmitter coil set, a first receiver coil set, a second transmitter coil set, and a second receiver coil set that each comprises at least two coils. The circuit board may further comprise: a first electronic control unit (ECU) associated with the first transmitter coil set and the first receiver coil set; and a second ECU that is separate from the first ECU, the second ECU being associated with the second transmitter coil set and the second receiver coil set.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a cross-sectional view of a steering column having an inductive sensor system according to an embodiment of the present disclosure.

FIG. 2 is a top view of an inductive sensor system according to an embodiment of the present disclosure.

FIG. 3 is a bottom view of an inductive sensor system according to an embodiment of the present disclosure.

FIG. 4A is a graph for showing linear torque signals generated by an inductive torque assembly of an inductive sensor system according to an embodiment of the present disclosure.

FIG. 4B is a graph for showing output signals of primary and auxiliary position sensor assemblies of an inductive sensor system according to an embodiment of the present disclosure.

FIG. 5 is a conceptual diagram for illustrating a controller and a process of detecting a torque applied to a steering wheel according to an embodiment of the present disclosure.

FIG. 6 is a block diagram of a controller according to an embodiment of the present disclosure.

FIGS. 7A and 7B show tables including coil placement combinations for coils of one or more coil sets according to an embodiment of the present disclosure.

FIG. 8 shows an example inductive sensor having one of the coil placement combinations according to an embodiment of the present disclosure.

FIGS. 9A and 9B show example coil assemblies according to an embodiment of the present disclosure.

FIG. 10 is a schematic view of a vehicle including a steering system and a brake assembly according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

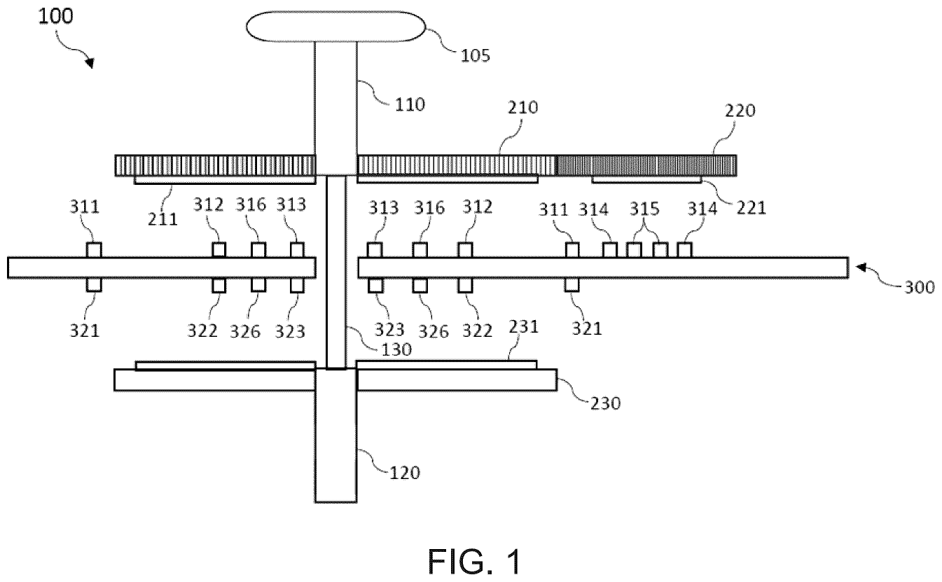

FIG. 1 is a cross-sectional view of a steering column having an inductive sensor system according to an embodiment of the present disclosure.

The inductive sensor system according an embodiment of the present disclosure may comprise a torque sensor assembly and an angle sensor assembly. The torque sensor assembly is required for information about torque applied to a steering wheel which is proportion to a relative position between an upper shaft and a lower shaft. The angle sensor assembly is required for absolute position information of the upper shaft or the lower shaft. The angle sensor assembly provides an output signal that is proportional to the rotation angle of the upper shaft or the lower shaft.

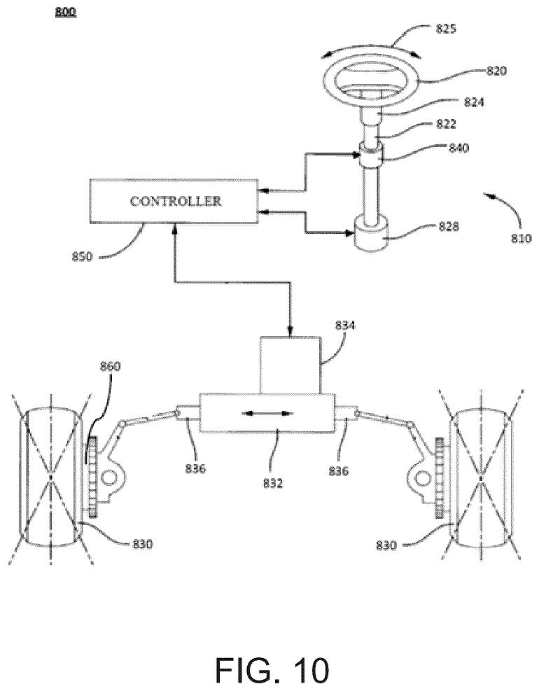

A vehicle (see e.g., FIG. 10) has a steering column 100 includes an upper shaft (or an input shaft) 110 and a lower shaft (or an output shaft) 120. The upper shaft 110 may be mechanically connected or fixed to a steering wheel 105 and the lower shaft 120 may be mechanically connected to vehicle wheels in a conventional mechanical steering system or a feedback actuator (e.g. an electric motor) in a steer-by-wire steering system. The upper shaft 110 and the lower shaft 120 may be axially aligned with each other.

The upper shaft 110 and the lower shaft 120 are connected by a torsion bar or beam 130. The torsion bar 130 may be configured to allow the upper shaft 110 and the lower shaft 120 to rotate slightly relative to each other in response to torque applied to the steering wheel 105.

An upper rotor 210 is fixedly coupled to the upper shaft 110 or is a part of the upper shaft 110. The upper rotor 210 is configured to be rotatable together with the upper shaft 110. For example, the upper rotor 210 may be a floating printed circuit board (PCB).

A lower rotor 230 is fixedly coupled to the lower shaft 120 or is a part of the lower shaft 120. The lower rotor 230 is configured to be rotatable together with the lower shaft 120. For example, the lower rotor 230 may be a floating PCB.

A stator 300 (e.g. a stationary circuit board) may be positioned between the upper rotor 210 and the lower rotor 230. The stator 300 is coaxially mounted around the steering column 100. For example, the stator 300 may be adjacent around the torsion bar 130. Alternatively, the stator 300 may be located adjacent around the upper rotor 210 or the lower rotor 230. The stator 300 may be fixed by being directly or indirectly coupled to a vehicle body. Accordingly, the stator 300 does not move relative to the steering column 100, while the upper rotor 210 can rotate with the upper shaft 110 and the lower rotor 230 can rotate with the lower shaft 120 relative to the stator 300. The stator 300 may be arranged to be parallel to the upper rotor 210 and/or the lower rotor 230.

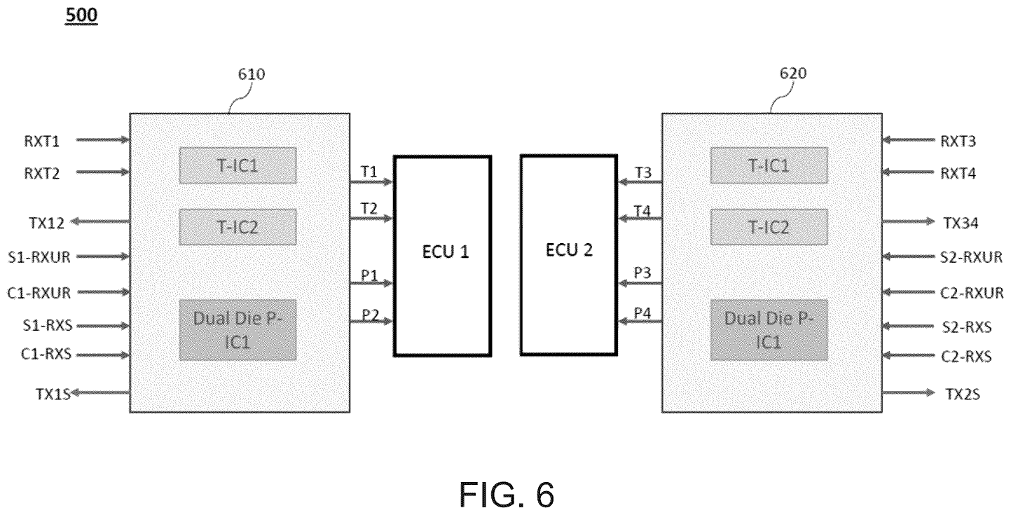

An oscillator 400 illustrated in FIG. 5 may be configured to oscillate at a high frequency, for example, but not limited to, 2 to 4 MHz. The oscillator 400 may be electrically connected to one or more excitation or transmitter coil sets 312 and/or 322, and an auxiliary excitation or transmitter coil set 315 to excite one or more relative angular displacement receiver coil sets 311 and 321, an upper angular position receiver coil set 313, a lower angular position receiver coil set 323, and an auxiliary angular position receiver coil set 314.

One or more excitation or transmitter coil set 312 and/or 322 are included in the stator 30 and/or disposed on an upper and/or lower surface of the stator 300. For example, the excitation or transmitter coil set 312 and/or 322 may be formed by conductive traces on the upper or lower surface of the stator 300 or electrically conductive pathways on a multi-layer PCB of the stator 300. As an example, at least a part of one coil of the excitation or transmitter coil set 312 and/or 322 is placed on one layer of the multi-layer PCB of the stator 300, and at least a part of another coil of the excitation or transmitter coil set 312 and/or 322 is placed on another layer of the multi-layer PCB of the stator 300. The excitation or transmitter coil set 312 and/or 322 is electronically connected to the oscillator 400. The excitation or transmitter coil set 312 and/or 322 generates an electromagnetic field over an upper target 211 of the upper rotor 210 and the lower target 231 of the lower rotor 230 by a radio-frequency signal generated by the oscillator 400. In FIG. 1, one excitation or transmitter coil set 312 for one transmittal channel is disposed on the upper surface of the stator 300 and the other excitation or transmitter coil set 322 for another transmittal channel is disposed on the lower surface of the stator 300. However, an excitation or transmitter coil set can be positioned on either one of the upper surface of the stator 300 or the lower surface of the stator 300. Alternatively, one or more excitation or transmitter coil sets may be positioned between the multiple layers of the multi-layer PCB of the stator 300.

The upper target 211 may be included in or attached to the upper rotor 210. The upper target 211 may be an electrically conductive coupler. The upper target 211 may be placed in proximity to the excitation or transmitter coil set 312 and/or 322. The upper target 211 may have a first metallic pattern. For instance, the upper target 221 can include a closed conductive loop or multiple conductive loops. The upper target 211 may have, for example, but not limited to, a multi lobe shape having the plurality of circumferentially adjacent lobes. The upper target 211 can be configured to affect the electromagnetic field generated by the excitation or transmitter coil set 312 and/or 322.

The lower target 231 may be included in or attached to the lower rotor 230. The lower target 231 may be an electrically conductive coupler. The lower target 231 may be placed in proximity to the excitation or transmitter coil set 322 and/or 312. The lower target 231 may have a second metallic pattern. For instance, the lower target 231 can include a closed conductive loop or multiple conductive loops. The lower target 231 may have, for example, but not limited to, a multi lobe shape having the plurality of circumferentially adjacent lobes. The second metallic pattern of the lower target 231 may be identical or different to or from the first metallic pattern of the upper target 211. The lower target 231 can be configured to affect the electromagnetic field generated by the excitation or transmitter coil set 312 and/or 322.

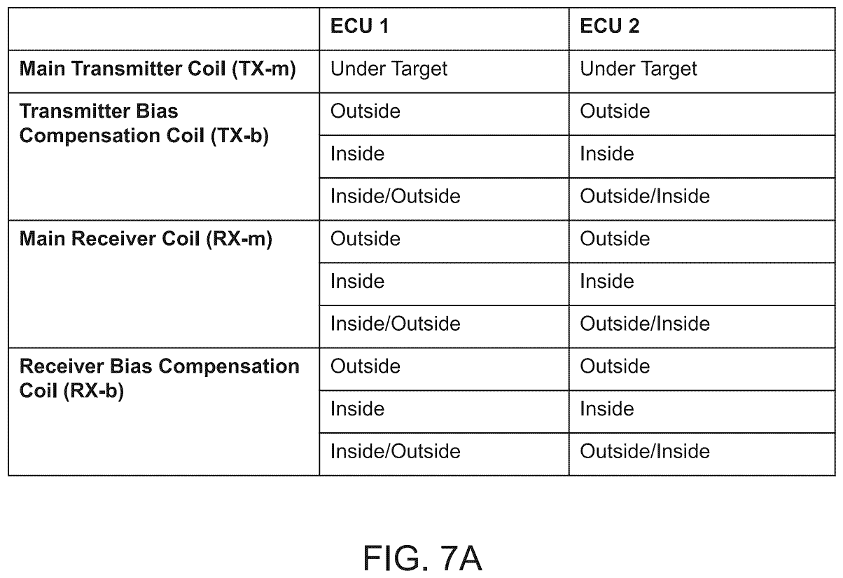

One or more relative angular displacement receiver coil sets 311 and 321 for sensing relative angular displacement movement between the upper rotor 210 and the lower rotor 230 are included in or disposed on an upper and/or lower surface of the stator 300. For example, the relative angular displacement receiver coil sets 311 and/or 321 may be formed by conductive traces on the upper and/or lower surface of the stator 300 or electrically conductive pathways on a multi-layer PCB of the stator 300. The relative angular displacement receiver coil set 311 and 321 may be placed in proximity to the upper target 211 and the lower target 231 and positioned within the electromagnetic fields generated by the transmitter coil set 312 and/or 322. The relative angular displacement receiver coil set 311 and 321 may be configured to generate a signal (e.g. voltage or current) in response to induction by the electromagnetic fields generated by the transmitter coil set 312 and 322 and altered by the upper target 211 and the lower target 231. The relative angular displacement receiver coil set 311 and/or 321 is electrically connected to a controller 500, illustrated in FIGS. 5 and 6, to output the signal (e.g. voltage or current) to the controller 500.

The relative angular displacement receiver coil sets 311 and/or 321 for sensing relative angular displacement movement between the upper rotor 210 and the lower rotor 230 may be positioned radially outside the metallic pattern of the upper target 211 and the lower target 231. The relative angular displacement receiver coil sets 311 and/or 321 are circularly wound. A winding diameter of the relative angular displacement receiver coil set 311 and/or 321 for sensing the relative angular displacement movement between the upper rotor 210 and the lower rotor 230 is greater than a winding diameter of the excitation or transmitter coil 312 and/or 322. The relative angular displacement receiver coil set 311 and/or 321 for sensing the relative angular displacement movement between the upper rotor 210 and the lower rotor 230 may surround the excitation or transmitter coil set 312 and/or 322. By arranging the relative angular displacement receiver coil set 311 and/or 321 for sensing relative angular displacement movement between the upper rotor 210 and the lower rotor 230 radially outside the metallic pattern of the upper target 211 and/or the lower target 231, the rotational accuracy for sensing the torque applied to the steering wheel 105 such as the relative angular displacement movement between the upper rotor 210 and the lower rotor 230 can be improved.

Alternatively, the relative angular displacement receiver coil sets 311 and/or 321 for sensing relative angular displacement movement between the upper rotor 210 and the lower rotor 230 may be positioned radially inside the metallic pattern of the upper target 211 and the lower target 231. Or, one or more of the relative angular displacement receiver coil sets 311 and/or 321 for sensing relative angular displacement movement between the upper rotor 210 and the lower rotor 230 may be positioned radially inside the metallic pattern of the upper target 211 and the lower target 231, while remaining another or other of the relative angular displacement receiver coil sets 311 and/or 321 for sensing relative angular displacement movement between the upper rotor 210 and the lower rotor 230 may be positioned radially outside the metallic pattern of the upper target 211 and the lower target 231.

A reference signal can be determined from a combination of receiver signals, substantially independent of angular positions of the upper target 211 of the upper rotor 210 and angular positions of the lower target 231 of the lower rotor 230, and this may be used to determine the number of rotations. Alternatively, a separate reference coil set 316 and/or 326 may be included in the stator 30 or disposed on an upper and/or lower surface of the stator 300. For example, the reference coil set 316 and/or 326 may be included in the stator 300 to provide a reference signal. The reference coil set 316 and/or 326 may be formed by conductive traces on the upper and/or lower surface of the stator 300 or electrically conductive pathways on a multi-layer PCB of the stator 300. The reference coil set 316 and/or 326 may have a similar configuration to the relative angular displacement receiver coil set 311 and/or 321, but can be configured in such a way that a reference current or voltage induced in the reference coil by the transmitter coil is substantially independent of the position of the upper target 211 of the upper rotor 210 and the lower target 231 of the lower rotor 230. The angular position or rotation of the upper target 211 of the upper rotor 210 and the lower target 231 of the lower rotor 230 does not affect the voltage or current induced into the reference coil set 316 and/or 326. However, common mode signals such as electromagnetic interference, variations in exciter voltage, variations produced by temperature changes, and variations in the gap between the upper target 211 of the upper rotor 210 and the stator 300 and the gap between the lower target 231 of the lower rotor 230 and the stator 300, will affect the voltage or current induced in the reference coil set 316 and/or 326 in the same way that they affect the voltage or current induced in the relative angular displacement receiver coil set 311 and/or 321. By using a difference or ratio of the output signal of the relative angular displacement receiver coil set 311 and/or 321 and the output signal of the reference coil set 316 and/or 326, the effects of the common mode factors can be suppressed. The reference coil set 316 and/or 326 may be circularly wound. A winding diameter of the reference coil set 316 and/or 326 may be smaller than both a winding diameter of the relative angular displacement receiver coil set 311 and/or 321 for sensing the relative angular displacement movement between the upper rotor 210 and the lower rotor 230 and a winding diameter of the excitation or transmitter coil set 312 and/or 322 in order to minimize the effect from the electromagnet fields associated with the excitation or transmitter coil 312 and/or 322 and the upper or lower target 211 or 231 of the upper or lower rotor 210 or 230.

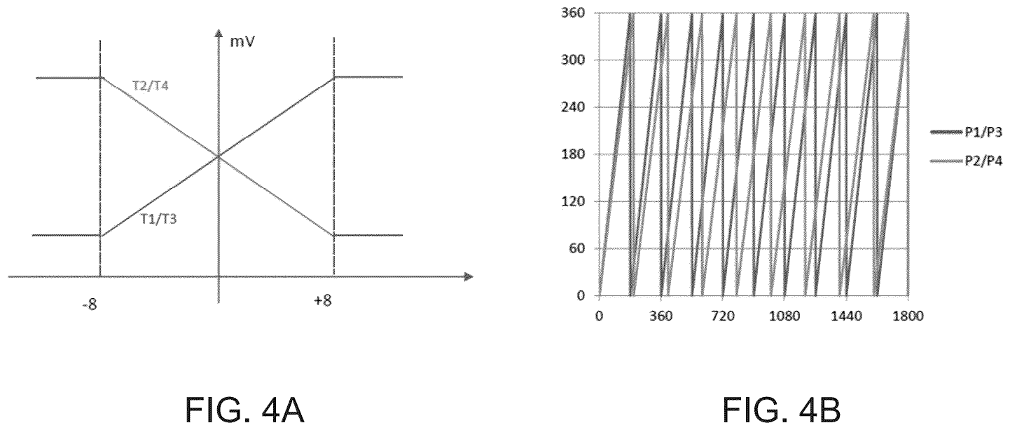

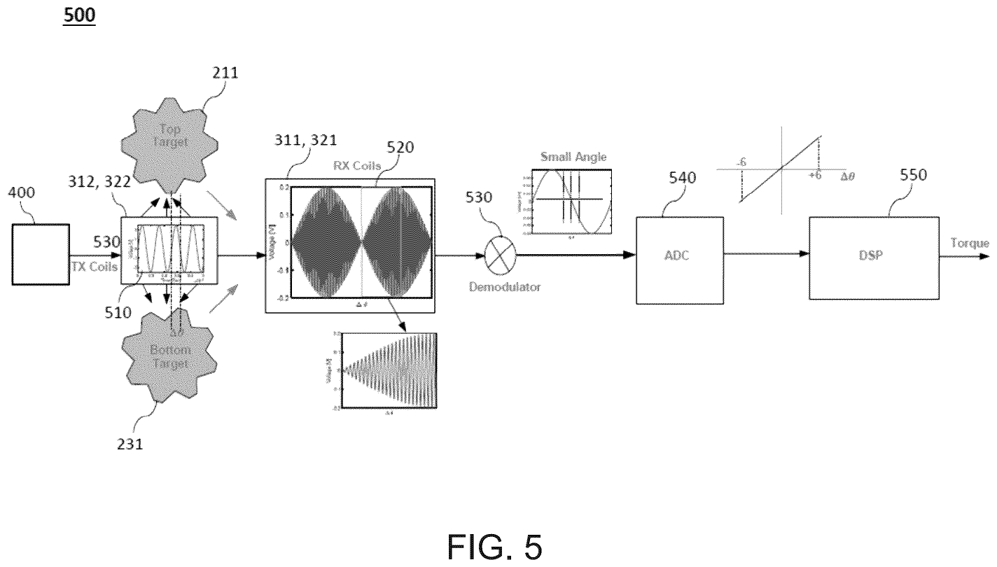

A torque determination may be made based on output signals of the relative angular displacement receiver coil set 311 and/or 321. The output signals such as output voltages or currents of the relative angular displacement receiver coil set 311 and/or 321 can be used for sensing the relative angular displacement movement between the upper rotor 210 and the lower rotor 230. The relative angular displacement movement between the upper rotor 210 and the lower rotor 230 is directly related to the torque or torsion applied to the steering wheel 105. For example, by having the circularly wound relative angular displacement receiver coil set 311 and/or 321, the output signal of the relative angular displacement receiver coil set 311 and/or 321 can be processed to provide a single linear signal over the torque applied the steering wheel 105 as illustrated in FIG. 4A. An exemplary embodiment of a process for generating a single linear signal over the torque applied the steering wheel 105 will be described later with reference to FIG. 5.

Since each of the relative angular displacement receiver coil set 311 and/or 321 includes an even number of oppositely wound loops, the output voltage on the relative angular displacement receiver coil set 311 and/or 321 may be indicative of a zero deflection between the upper shaft 110 and the lower shaft 120, while a positive voltage may be indicative of torque in one direction between the upper shaft 110 and the lower shaft 120 and a negative voltage may be indicative of torque in the other direction between the upper shaft 110 and the lower shaft 120.

FIG. 5 is a conceptual diagram for illustrating a controller and a process of detecting a torque applied to a steering wheel according to an embodiment of the present disclosure.

The controller 500 may include an electronic circuit such as an ASIC. The controller 500 is configured as a micro-processor configured to execute non-transient computer executable, instructions that are suitably stored on firmware, software, or otherwise for use in performing functions. Ends of the relative angular displacement receiver coil set 311 and/or 321 and the reference coil set 316 and 326 are connected to the controller 500 to process their output signals. The controller 500 may have a processor programmed to output the magnitude and direction of the relative angular displacement between the upper shaft 110 and the lower shaft 120 and the absolute rotational position of the upper shaft 110 and/or the lower shaft 120.

The oscillator 400 is connected to the ends of the excitation or transmitter coil set 312 and/or 322. The oscillator 400 provides excitation signals 510 such as alternating currents to the excitation or transmitter coil set 312 and/or 322, thereby generating an alternating electromagnetic field, which subsequently induces signals in the excitation or transmitter coil set 312 and/or 322 through inductive coupling. The inductive coupling between the excitation or transmitter coil sets 312 and 322 and the receiver coil sets 311 and 321 is changed (e.g. reduced) by the targets 211 and 231 of the rotors 210 and 230. However, the inductive coupling between the excitation or transmitter coil sets 312 and 322 and the reference coil sets 316 and 326 is not sensitive to the angular position of the targets 211 and 231 of the rotors 210 and 230. In contrast, the output signals 520 of the receiver coil sets 311 and 321 are sensitive to the angular position of the targets 211 and 231 of the rotors 210 and 230, so that a ratio of the output signals 520 of the receiver coil sets 311 and 321 and the output signals of the reference coil sets 316 and 326 is correlated with the angular position of the targets 211 and 231 of the rotors 210 and 230 while also being corrected for common mode factors as discussed above.

A demodulator 530 demodulates the output signal 520 combined by the output signal of the receiver coil sets 311 and 321 and the output signal of the reference coil sets 316 and 326, an analog-to-digital converter (ADC) 540 converts the demodulated output signal to an analog signal, and a digital signal processor (DSP) 550 processes the converted analog signal to output an output signal indicative of the torque applied to the steering wheel 105. The output signal indicative of the torque applied to the steering wheel 105 may be a linear output voltage as a function of angular displacement between the upper rotor 210 and the lower rotor 230 as illustrated in FIG. 4A.

However, the relative angular displacement receiver coil set 311 and/or 321 cannot provide an absolute angular rotational position of the upper rotor 210 and the lower rotor 230.

In order to determine the absolute angular rotational position of the upper rotor 210 and the lower rotor 230, an auxiliary or satellite rotor 220 may be further included.

The auxiliary or satellite rotor 220 may be rotatably engaged with the upper rotor 210. For instance, the upper rotor 210 and the auxiliary or satellite rotor 220 may have gear teeth meshed with each other. The number of teeth of the upper rotor 210 is different from the number of the auxiliary or satellite rotor 220 so that the upper rotor 210 and the auxiliary or satellite rotor 220 rotate at different rotational speeds. The rotation axis of the auxiliary or satellite rotor 220 is parallel to and spaced apart from the rotation axis of the upper shaft 110.

In a first exemplary embodiment for a position sensor assembly (an inductive sensing type), an auxiliary target 221 having a conductive material such as metal (e.g. aluminum or copper) may be included in or attached to the auxiliary or satellite rotor 220. The auxiliary target 221 may be an electrically conductive coupler. The auxiliary target 221 may have, for example, but not limited to, a partial circle or polygon shape such as a half circle or a half polygon. The auxiliary target 221 rotates above the auxiliary excitation or transmitter coil set 315 and dissipates the magnetic field generated by the auxiliary excitation or transmitter coil set 315, thereby creating an imbalance in the auxiliary receiver coil set 314 and consequently generating an output voltage in the auxiliary receiver coil set 314 depending on the angular position of the auxiliary target 221.

The auxiliary receiver coil set 314 and the auxiliary excitation or transmitter coil set 315 for sensing the absolute angular rotational position of the upper rotor 210 and/or the lower rotor 230 are included in or disposed on one of both surfaces of the stator 300, for instance, the upper surface of the stator 300. For example, the auxiliary receiver coil set 314 and the auxiliary excitation or transmitter coil set 315 may be formed by conductive traces on the upper surface of the stator 300 or electrically conductive pathways on a multi-layer PCB of the stator 300 at a position such that the auxiliary receiver coil set 314 faces the auxiliary target 221. The auxiliary receiver coil set 314 includes a plurality of oppositely wounded circumferentially adjacent loops which are electrically connected in series with each other. The auxiliary receiver coil set 314 and the auxiliary excitation or transmitter coil set 315 are electrically connected to the controller 500 to output a signal associated with the angular position of the auxiliary target 221 of the auxiliary or satellite rotor 220. The auxiliary receiver coil set 314 may have any shape such as a substantially sinusoidal or polygonal shape for sensing an absolute angular rotational position. The auxiliary excitation or transmitter coil set 315 may be circularly wound, but the auxiliary excitation or transmitter coil set 315 can have any shape if necessary.

An upper angular position receiver coil set 313 for sensing the absolute angular rotational position of the upper rotor 210 is included in or disposed on the upper surface of the stator 300. For example, the upper angular position receiver coil set 313 may be formed by conductive traces on the upper surface of the stator 300 or electrically conductive pathways on a multi-layer PCB of the stator 300 at a position such that the upper angular position receiver coil set 313 faces the upper target 211. The upper angular position receiver coil set 313 includes a plurality of oppositely wounded circumferentially adjacent loops which are electrically connected in series with each other. The upper angular position receiver coil set 313 is electrically connected to the controller 500 to output a signal associated with an angular position of the upper rotor 210. For example, the upper angular position receiver coil set 311 may include a sine receiver coil and a cosine receiver coil. The sine receiver coil and the cosine receiver coil included in the upper angular position receiver coil set 311 are surrounded by the excitation or transmitter coil set 312 and/or 322. The upper angular position receiver coil set 313 may have any shape such as a substantially sinusoidal or polygonal shape for sensing an absolute angular rotational position.

A lower angular position receiver coil set 323 for sensing the absolute angular rotational position of the lower rotor 230 is included in or disposed on the lower surface of the stator 300. For example, the lower angular position receiver coil set 323 may be formed by conductive traces on the lower surface of the stator 300 or electrically conductive pathways on a multi-layer PCB of the stator 300 at a position such that the lower angular position receiver coil 323 faces the lower target 231. The lower angular position receiver coil 323 includes a plurality of oppositely wounded circumferentially adjacent loops which are electrically connected in series with each other. The lower angular position receiver coil 323 is electrically connected to the controller 500 to output a signal associated with an angular position of the lower rotor 230. For instance, the lower angular position receiver coil set 323 may include a sine receiver coil and a cosine receiver coil. The sine receiver coil and the cosine receiver coil included in the lower angular position receiver coil set 323 are surrounded by the excitation or transmitter coil set 312 and/or 322. The lower angular position receiver coil set 323 may have any shape such as a substantially sinusoidal or polygonal shape for sensing an absolute angular rotational position.

In a second exemplary embodiment for a position sensor assembly (a magnet sensing type), a magnetic sensor (e.g. a Hall effect sensor) may be used to detect an absolute angle position of the upper rotor 210 and/or the lower rotor 230. For example, the auxiliary target 221 may comprise a magnet material such a permanent magnet, and the auxiliary receiver coil set 314 and the auxiliary excitation or transmitter coil 315 may be replaced with a magnetic sensor such as a Hall effect sensor. The magnetic field between the magnet material of the auxiliary target 221 and the magnet sensor 314 can be varied as a function of the angular displacement of the auxiliary target 221 of the auxiliary or satellite rotor 220.

Referring to FIG. 4B, the angular positions of the upper rotor 210 and the auxiliary or satellite rotor 220 are shown over a plurality of rotations, for instance, four rotations. The output signal of the upper angular position receiver coil set 313 associated with the upper target 211 of the upper rotor 210 has a first periodic pattern and the output signal of the auxiliary receiver coil set 314 associated with the auxiliary target 221 of the auxiliary or satellite rotor 220 has a second periodic pattern. The output signal of the upper angular position receiver coil set 313 repeats a first number of times during each revolution of the upper rotor 210, while the output signal of the auxiliary receiver coil 314 repeats a second number of times during each revolution of the auxiliary or satellite rotor 220. Therefore, because the output signals of the upper angular position receiver coil 313 and the auxiliary receiver coil 314 overlap only after a specific number of revolutions, the absolute angular rotational position of the upper rotor 210 or the steering wheel 105 can be calculated based on the output signals of the upper angular position receiver coil 313 and the auxiliary receiver coil 314 as programmed by the processor of the controller 500.

For instance, by utilizing the Vernier principle through using the mathematical difference or relation between the output signals of the upper angular position receiver coil 313 and the auxiliary receiver coil 314, the absolute angular rotational position of the upper rotor 210 or the steering wheel 105 can be calculated.

Likewise, the absolute angular position of the lower rotor 230 may be calculated in a similar way to the calculation of the upper rotor 210 described above.

FIGS. 1 to 3 illustrate that the auxiliary or satellite rotor 220 is engaged with the upper rotor 210 and is positioned above the stator 300. However, alternatively or additionally, the auxiliary or satellite rotor 220 can be engaged with the lower rotor 230 and is positioned below the stator 300.

In some embodiments of the present disclosure above, the torque sensor assembly and the angle sensor assembly share the same transmitter and the same target (e.g. the same conductive coupler) to save components and reduce possible interference between those two sensor assemblies. However, each of the torque sensor assembly and the angle sensor assembly can have its own transmitter and target.

FIG. 6 is a block diagram of a controller according to an embodiment of the present disclosure.

The controller 500 may comprises a first processor 610, a second processor 620, an electronic control unit (ECU) 1, and ECU 2.

The first processor 610 comprises the oscillator 400 configured to provide an excitation signal (TX12) to a first channel of the excitation or transmitter coil set 312 or 322 which can be inductively associated with the upper target 211 of the upper rotor 210 and the lower target 231 of the lower rotor 230. A first channel and a second channel of the relative angular displacement receiver coil set 311 and/or 321 for the torque sensor assembly receive electromagnetic signals influenced by the upper target 211 of the upper rotor 210 and the lower target 231 of the lower rotor 230, and output a first channel relative angular displacement receiver output signal (RXT1) and a second channel angular displacement receiver output signal (RXT2) to the first processor 610, respectively. The first processor 610 outputs a first channel torque output signal (T1) and a second channel torque output signal (T2) to ECU 1 in response to the first channel relative angular displacement receiver output signal (RXT1) and the second channel relative angular displacement receiver output signal (RXT2). An upper sine angular position receiver coil and an upper cosine angular position receiver coil included in the upper angular position receiver coil set 313 for sensing the absolute angular rotational position of the upper rotor 210 receive electromagnetic signals influenced by the upper target 211 of the upper rotor 210, and output a first sine angular position receiver output signal (S1-RXUR) and a first cosine angular position receiver output signal (C1-RXUR) to the first processor 610, respectively. An auxiliary sine receiver coil and an auxiliary cosine receiver coil included in the auxiliary receiver coil set 314 receive electromagnetic signals influenced by the auxiliary target 221 of the auxiliary or satellite rotor 220, and output a first auxiliary sine receiver output signal (S1-RXS) and a first cosine receiver output signal (C1-RXS) to the first processor 610, respectively. The first processor 610 outputs a first upper target position output signal (Pl) and a second upper target position output signal (P2) to ECU 1 in response to the first sine receiver angular position output signal (S1-RXUR), the first cosine angular position receiver output signal (C1-RXUR), the first auxiliary sine angular position receiver output signal (S1-RXS), and the first cosine angular position receiver output signal (C1-RXS).

The second processor 620 comprises the oscillator 400 configured to provide an excitation signal (TX34) to a second channel of the excitation or transmitter coil set 312 or 322 which can be inductively associated with the upper target 211 of the upper rotor 210 and the lower target 231 of the lower rotor 230. A third channel and a fourth channel of the relative angular displacement receiver coil set 311 and/or 321 for the torque sensor assembly receive electromagnetic signals influenced by the upper target 211 of the upper rotor 210 and the lower target 231 of the lower rotor 230, and output a third channel relative angular displacement receiver output signal (RXT3) and a fourth channel relative angular displacement receiver output signal (RXT4) to the second processor 620, respectively. The second processor 620 outputs a third channel torque output signal (T3) and a fourth channel torque output signal (T4) to ECU 2 in response to the third channel relative angular displacement receiver output signal (RXT3) and the fourth channel relative angular displacement receiver output signal (RXT4). An lower sine angular position receiver coil and an lower cosine angular position receiver coil included in the lower angular position receiver coil set 323 for sensing the absolute angular rotational position of the lower rotor 230 receive electromagnetic signals influenced by the lower target 231 of the lower rotor 230, and output a second sine angular position receiver output signal (S2-RXUR) and a second cosine angular position receiver output signal (S2-RXUR) to the second processor 620, respectively. A second auxiliary sine angular position receiver coil and a second auxiliary cosine angular position receiver coil included in the auxiliary receiver coil set 314 receive electromagnetic signals influenced by the auxiliary target 221 of the auxiliary or satellite rotor 220, and output a second auxiliary sine angular position receiver output signal (S2-RXS) and a second cosine angular position receiver output signal (C2-RXS) to the second processor 620, respectively. The second processor 560 outputs a first lower target position output signal (P3) and a second lower target position output signal (P4) to ECU 2 in response to the second sine angular position receiver output signal (S2-RXUR), the second cosine angular position receiver output signal (C2-RXUR), the second auxiliary sine angular position receiver output signal (S2-RXS), and the second cosine angular position receiver output signal (C2-RXS).

ECU 1 and ECU 2 can calculate the relative angular displacement movement between the upper rotor 210 and the lower rotor 230 using the first channel torque output signal (T1), the second channel torque output signal (T2), the third channel torque output signal (T3), and the fourth channel torque output signal (T4) to determine the torque applied to the steering wheel 105 as illustrated in FIG. 4A, and can calculate the absolute angular positions of the upper rotor 210 and the lower rotor 230 using the first upper target position output signal (P1), the second upper target position output signal (P2), the first lower target position output signal (P3), and the second lower targe position output signal (P4) to determine the absolute angular position of the upper rotor 210 and lower rotor 230 as illustrated in FIG. 4B.

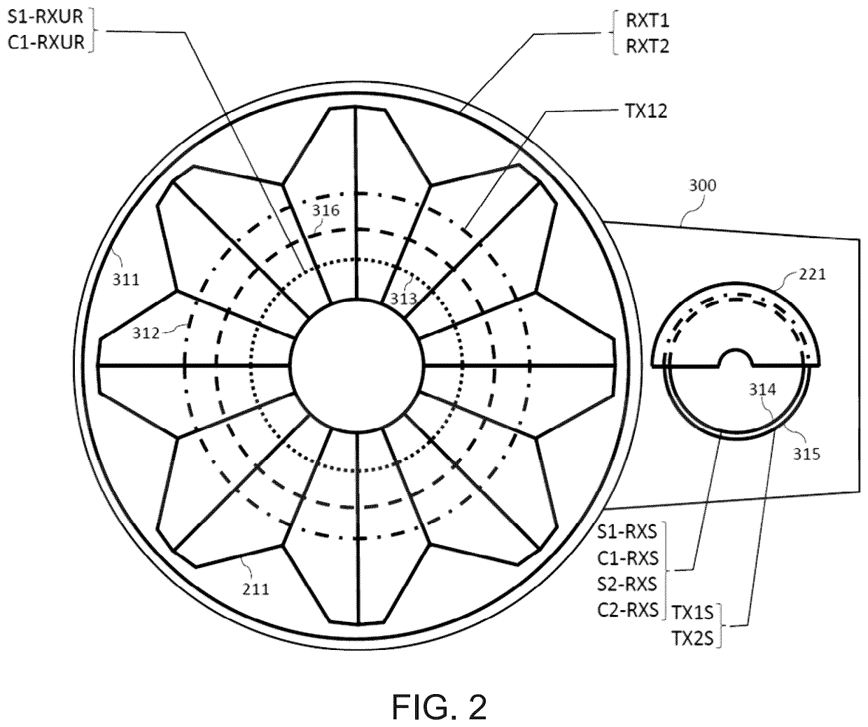

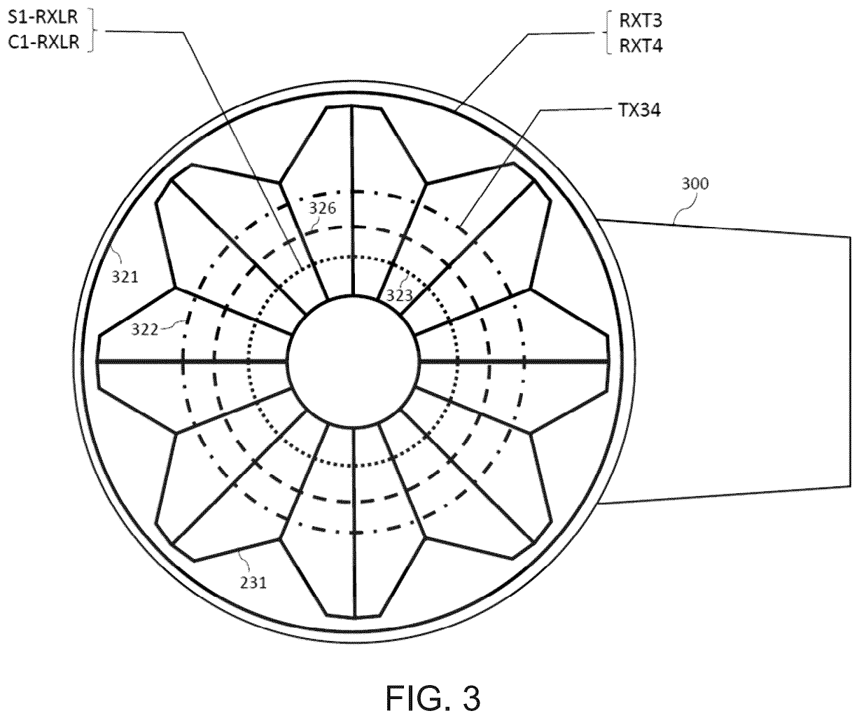

As discussed above in reference to FIGS. 1-6, the inductive sensor system of embodiments disclosed herein may have, at least, two transmitter coils (e.g., transmitter coil sets 312 and/or 322) and two receiver coils (e.g., the relative angular displacement receiver coil sets 311 and/or 321), which is also referred to herein as a “redundant coil set structure”. A placement (e.g., installation position and spacing or the like) of the two transmitter coils may cause mutual coupling between the two transmitter coils, which results in adverse cross talk between the two transmitter coils. Similar adverse cross talk may occur between the two receiver coils and/or any of the other coils (e.g., 312, 316, 313, 322, 326, 323, etc.) shown above in reference to FIGS. 2-3.

To reduce and/or eliminate such adverse cross talk between these coils (e.g., the transmitter coils, the receiver coils, and/or any of the other coils shown in FIGS. 2-3), the coils must be spaced far apart from one another. Such spacing apart usually requires an in increase in the size (e.g., in surface area, width, etc.) of the PCB (e.g., PCB of the stator 300), which not only increases the costs of such PCB but also makes installation of such PCB within the limited space inside the vehicle more difficult.

As a result, embodiments disclosed herein include new coil designs that not only advantageously reduces the adverse cross talk between the coils but also advantageously allows the size of the PCB to remain the same (e.g., not requiring an increase in the size of the PCB for the cross talk to be minimized and/or eliminated).

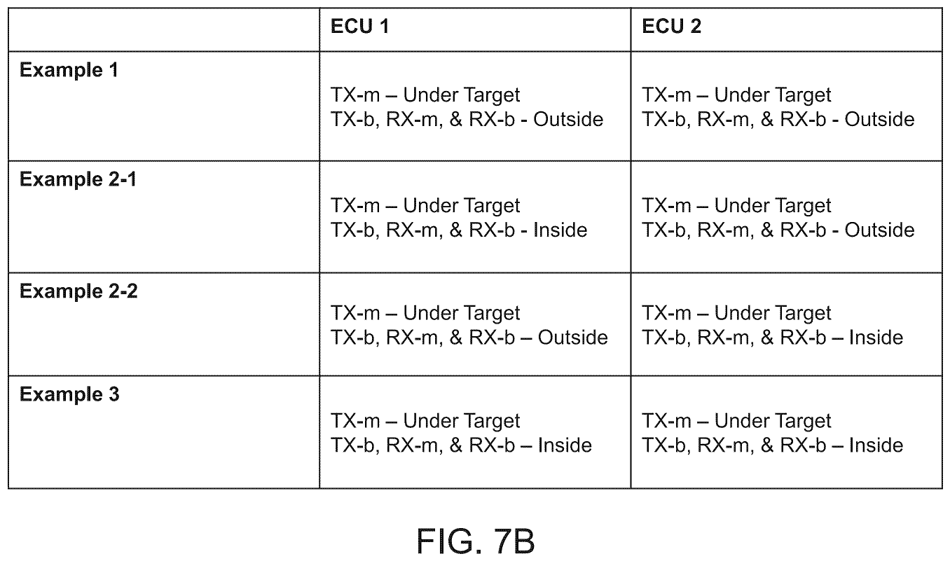

In particular, turning now to FIG. 7A, FIG. 7A shows a table including coil set combinations according to an embodiment of the present disclosure. The coil set combinations may be for the placement of at least the excitation or transmitter coil sets 312 and/or 322 and the relative angular displacement receiver coil sets 311 and 321 of FIGS. 1-6 on the stationary circuit board (e.g., stator 300).

In embodiments and as shown in FIG. 7A, each transmitter coil set (e.g., 312 and 322) may have a main transmitter coil (TX-m) and a transmitter bias compensation coil (TX-b) (also referred to herein as a “transmitter bias coil”). Each receiver coil set (e.g., 311 and 321) may also have a main receiver coil (RX-m) and a receiver bias compensation coil (RX-b) (also referred to herein as a “receiver bias coil”).

Each of these coils (i.e., TX-m, TX-b, RX-m, and RX-b) may be circularly wound coils. Each of these coils (i.e., TX-m, TX-b, RX-m, and RX-b) may also contain any number of turns and be positioned between any layers of the stationary circuit board. More specifically, the number of turns of each of these coils (i.e., TX-m, TX-b, RX-m, and RX-b) and the positioning of these coils (i.e., TX-m, TX-b, RX-m, and RX-b) between the layers of the stationary circuit board may depend of various factors such as, but not limited to: manufacturer design and preference; the amount of space on the stationary circuit board; the number of layers of the stationary circuit board; or the like.

As further shown in FIG. 7A, each of these coils (e.g., TX-m, TX-b, RX-m, and RX-b) may be positioned on the stationary circuit board at one of the following positions: (i) an under target position; (ii) an outside position; and (iii) an inside position. The placement of these coils (e.g., TX-m, TX-b, RX-m, and RX-b) in the combination of these positions (i.e., the under target position, the outer position, the inside position) is critical for the reduction and/or elimination of mutual coupling (i.e., adverse cross talk) between these coils. Said another way, the placement of these coils (e.g., TX-m, TX-b, RX-m, and RX-b) in the combination of these positions shown in FIG. 7A is not a mere rearrangement of parts (e.g., a rearrangement of the coils) but instead a specific design that results in a criticality (e.g., reduction and/or elimination of mutual coupling/adverse crosstalk) the of embodiments disclosed herein.

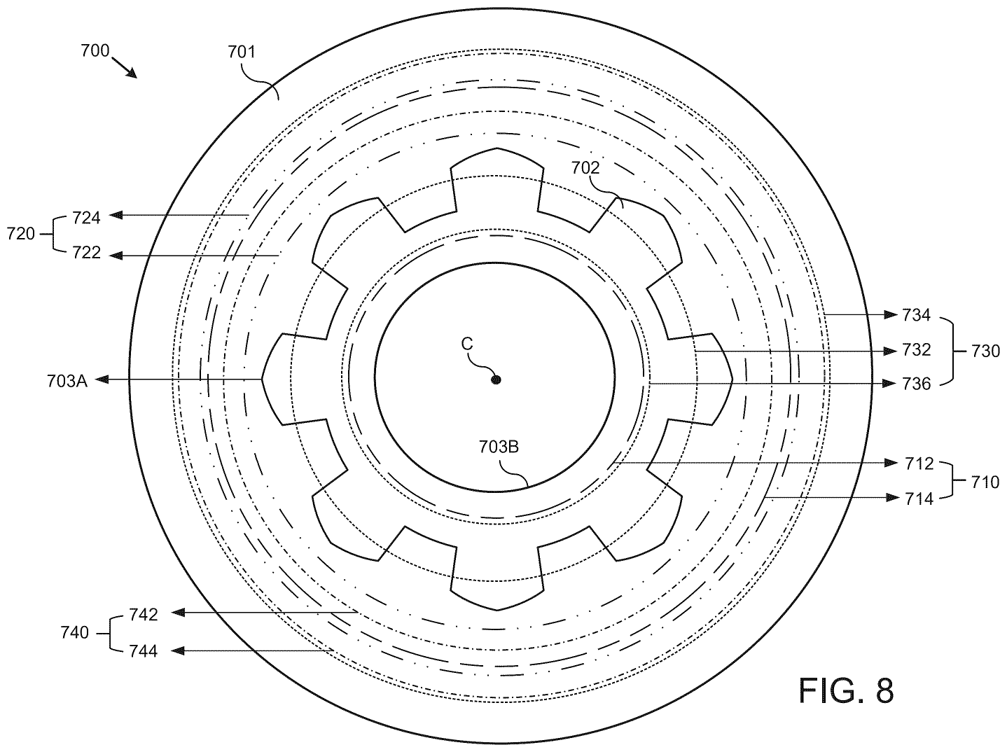

In embodiments, the under target position requires the coil(s) to be positioned (e.g., radially positioned) between an outer diameter and an inner diameter of the targets (e.g., upper target 211 and lower target 231). More specifically, from a top-down view of the inductive sensory system, the coil(s) positioned at the under target position will be sandwiched between the metal targets. An example of the under target position is shown in FIG. 8 discussed below.

The outside position requires the coil(s) to be positioned (e.g., radially positioned) outside of an outer diameter of (e.g., both or a single one of) the targets (e.g., upper target 211 and lower target 231). The inside position requires the coil(s) to be positioned (e.g., radially positioned) inside of an inner diameter of (e.g., both or a single one of) the targets (e.g., upper target 211 and lower target 231).

A further shown in FIG. 7A, each of the ECUs (i.e., ECU 1 and ECU 2) may be associated with at least one transmitter coil set (e.g., to provide the excitation signals to the transmitter coil set, or the like) and at least one receiver coil set (e.g., to receive signals from the receiver coil set in response to exciting the transmitter coil set, or the like).

In embodiments, a coil set (e.g., transmitter and/or receiver coil set) may be configured (e.g., formed) as a single coil (i.e., one physical un-cut piece of coil) with separate portions of the single coil being configured as the main portion and the bias portion. For example, any one of the transmitter coil set or receiver coil set may be a single, monolithic, un-cut coil having a first circularly wound portion configured as the TX-m or RX-m, respectively, and a second circularly wound portion configured as the TX-b or RX-b, respectively.

A coil set (e.g., transmitter and/or receiver coil set) may also be configured (e.g., formed) as multiple coils that are electrically connected to one another. For example, any one of the transmitter coil set or receiver coil set may have a first coil circularly wound as the TX-m or RX-m, respectively, and a second coil (that is separate from the first coil) circularly wound as the TX-m or RX-m, respectively. In this example, the first coil may be physically and electrically connected to the second coil with either one or both of the first or second coil being connected to one of the ECUs.

Other configurations and/or structures may also be used for each of the coil sets without departing from the scope of embodiments disclosed herein.

Turning now to FIG. 7B, FIG. 7B shows example combinations of the positions (i.e., coil placement positions) shown in the table of FIG. 7A. As shown in FIG. 7B, the TX-m coils of the respective transmitter coil sets of ECU 1 and ECU 2 are always placed at the under target position in order for the transmitter coil sets to be able to excite the targets (e.g., upper target 211 and lower target 231). The remaining coils (i.e., TX-b, RX-m, and RX-b) of the coil sets are then positioned at either the outside position or the inside position.

Although FIG. 7B shows a limited number of examples, embodiments disclosed herein are not limited to the examples shown in FIG. 7B. In particular, only four (4) examples are shown for the sake of brevity. However, any number of examples and/or combinations can be made based on the coil placement combinations (e.g., for TX-m, TX-b, RX-m, and RX-b) shown in FIG. 7A.

Additionally, as long as the TX-ms of the respective transmitter coil sets of ECU 1 and ECU 2 are placed at the under target position, any other ones of the remaining coils (i.e., TX-b, RX-m, and RX-b) may also be placed at the under target position. The placement of the remaining coils (i.e., TX-b, RX-m, and RX-b) may be based on factors such as, but not limited to: manufacturer design and preference; the amount of space on the stationary circuit board; the number of layers of the stationary circuit board; or the like. The placement of each of these coils (i.e., TX-m, TX-b, RX-m, and RX-b) may then in turn effect other characteristics and/or configurations of these coils such as, but not limited to: coil width, coil turns, distance between each coil of a respective coil set, distance between any one of the coils, placement and/or layering of each coil between the layers of the stationary circuit board, or the like.

As discussed above, the placement of these coils (e.g., TX-m, TX-b, RX-m, and RX-b) in the example combinations shown in FIG. 7B is critical for the reduction and/or elimination of mutual coupling (i.e., adverse cross talk) between these coils. Said another way, the placement of these coils (e.g., TX-m, TX-b, RX-m, and RX-b) in the example combinations shown in FIG. 7B is not a mere rearrangement of parts (e.g., a rearrangement of the coils) but instead a specific design that results in a criticality (e.g., reduction and/or elimination of mutual coupling/adverse crosstalk) the of embodiments disclosed herein.

Turning now to FIG. 8, FIG. 8 shows an example inductive sensor 700 having example coil placement combination 1 (i.e., example 1) of FIG. 7B. The example inductive sensor 700 of FIG. 8 is shown from a top-down perspective of printed circuit board 701 where only one of the two targets (e.g., upper target 211) is shown as target 702. The target 702 in FIG. 8 having an outer diameter at 703A and an inner diameter at 703B. Any coils overlapping target 702 are considered as being placed at the under target position. Any coils positioned (e.g., radially positioned) outside of the outer diameter 703A are considered as being placed at the outer position. Finally, any coils positioned (e.g., radially positioned) inside of the inner diameter 703B are considered as being placed at the inside position.

As shown in FIG. 8, a first transmitter coil set 710 (e.g., for and/or associated with ECU 1) comprises TX-m 712 at the under target position and TX-b 714 at the outside position. A first receiver coil set 720 (e.g., for and/or associated with ECU 1) comprises RX-m 722 and RX-b 724 that are both at the outside position.

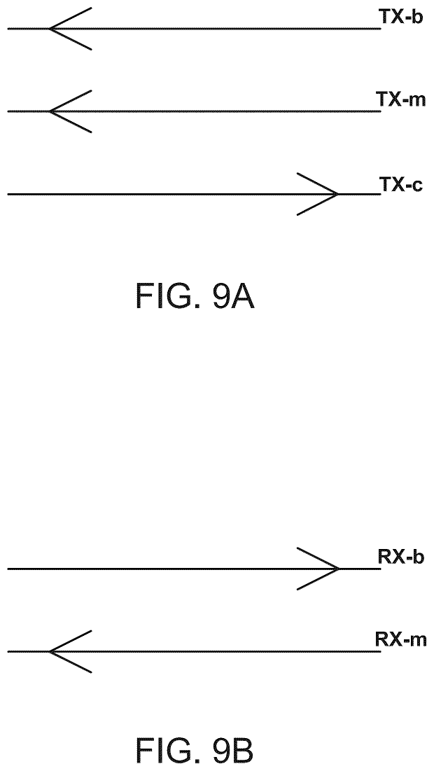

As further shown in FIG. 8, a second transmitter coil set 730 (e.g., for and/or associated with ECU 2) comprises TX-m 732 at the under target position and TX-b 734 at the outside position. This second transmitter coil set 730 further includes a compensation coil (TX-c) 736 that is positioned (e.g., radially positioned) closer toward a center point C (e.g., for determining a radius of each circularly wound coil, which may also be a center point of the target 702) than the TX-m 732. This compensation coil TX-c 736 (which may also be referred to herein as a “cancelation coil”) will be discussed in more detail below in reference to FIGS. 9A-9B.

Finally, a first receiver coil set 740 (e.g., for and/or associated with ECU 2) comprises RX-m 742 and RX-b 744 that are both at the outside position.

Turning now to FIG. 9A and 9B, FIG. 9A shows, a transmitter coil set having a compensation coil (e.g., TX-c) and a current flow direction of each of the coils of the transmitter coil set.

In embodiments, for the transmitter coil set, the compensation coil (e.g., TX-c) may be formed as part of the single coil forming the other portions (e.g., the main and bias portions). Said another way, the transmitter coil set may be formed as a single, monolithic, un-cut coil having three separate portions (e.g., the main portion, the bias portion, and the compensation portion). Alternatively, a transmitter coil set may be made up of three separate coils (e.g., one each for the main, bias, and compensation coils) that are physically and electrically connected to one another.

Additionally, a transmitter compensation coil TX-c may be included (e.g., added) for a transmitter coil set if a distance between the TX-m of ECU 1 and the TX-m of ECU 2 is less than at least 5 mm (e.g., if the two TX-m coils are positioned (e.g., radially positioned) less than at least 5 mm apart). The compensation coil TX-c then acts to advantageously reduce, cancel, and/or eliminate any mutual coupling present between the two TX-m coils when these two coils are positioned (e.g., radially positioned) less than at least 5 mm apart. Although 5 mm is used as a specific distance example, one of ordinary skill may appreciate that this distance is not limited to 5 mm and any distance (e.g., a distance of greater than 5 mm) may be used as long as any amount of mutual coupling is observed and/or present between the two coils (i.e., the two TX-m coils of ECU 1 and ECU 2).

Both transmitter coil sets (for ECU 1 and ECU 2) may have the transmitter compensation coil TX-c. Alternatively, only one transmitter coil set (for ECU 1 or ECU 2) may have the transmitter compensation coil TX-c. In embodiments, the TX-c may have a diameter that is larger than the diameter of the TX-m of the same transmitter coil set. Alternatively, the TX-c may have a diameter that is smaller than that of the TX-m of the same transmitter coil set.

Additionally, the TX-c of a transmitter coil set may be configured to be positioned (e.g., radially positioned) proximate to the TX-m of that same transmitter coil set. For example, the TX-c of a transmitter coil set may be positioned within 2 mm (or the like) from the TX-m of the same transmitter coil set. The distance between the TX-c and the TX-m (e.g., 2 mm) may not be affected by a thickness of the TX-m.

Furthermore, as shown in FIG. 9A, the transmitter compensation coil TX-c may have a current flow that is opposite to (e.g., in an opposite direction to) a current flow within TX-m and TX-b. For example, if the TX-m and TX-b are physically wound in a clockwise manner, the TX-c will be physically wound in a counter-clockwise manner, and vice versa. In embodiments, a direction of current flow within TX-m and TX-b of any transmitter coil set will be the same.

Turning now to FIG. 9B, FIG. 9B shows a receiver coil set configuration and a current flow direction of each of the coils (e.g., RX-m and RX-b) of a receiver coil set. Unlike the transmitter coil set (as shown in FIG. 9A), receiver coil set(s) of embodiments disclosed herein will not have a separate compensation coil (i.e., only transmitter coil sets of embodiments disclosed herein will have a TX-c coil separate from the TX-m and TX-b coils while receiver coil sets of embodiments disclosed herein will only have RX-m and RX-b coils). Instead, the existing receiver bias compensation coil RX-b is configured to act as a compensation coil in order to cancel DC bias between the respective RX-m coils of ECU 1 and ECU 2.

In embodiments, to cancel the DC bias between the respective RX-m coils of ECU 1 and ECU 2, as shown in FIG. 9B, a current flow direction of RX-b (for a receiver coil set) will be configured to be in an opposite direction of a current flow direction of that same receiver coil set's RX-m coil. Said another way, for a receiver coil set, if the current within RX-m flows in a clockwise direction, the RX-b coil will be physically arranged such that current within the RX-b coil flows in a counter-clockwise direction, and vice versa (e.g., counter-clockwise for RX-m and clockwise for RX-b).

Additionally, the receiver bias compensation coil RX-B may be configured to cancel DC bias irrespective/regardless of the distance between the RX-m of ECU 1 and the RX-m of ECU 2 (i.e., the distance between the RX-m of ECU 1 and the RX-m of ECU 2 does not affect whether the RX-b should or should not exist).

Any of the above-discussed motor vehicles according to certain exemplary embodiments of the present disclosure may be identical, or substantially similar to, vehicle 800 shown in FIG. 10. The vehicle 800 may be any passenger or commercial automobile such as a hybrid vehicle, an electric vehicle, or any other type vehicles. FIG. 10 is a schematic view of a vehicle 800 including a steering system and a brake assembly according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 (e.g., the inductive sensor system discussed above in reference to FIGS. 1-9C) may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 10 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the application as defined by the appended claims.

In the present disclosure, relational terms such as first and second, and the like may be used solely to distinguish one entity or action from another entity or action without necessarily requiring or implying any actual such relationship or order between such entities or actions. Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements. The term “connected” or “coupled” may mean direct or indirect connection unless otherwise specified.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

The terms “comprises,” “comprising,” “includes,” “including,” “has,” “having,” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B may be satisfied by any one of the following: A is true (or present) and B is false (or not present), A is false (or not present) and B is true (or present), and both A and B are true (or present).

Although various embodiments of the claimed invention have been described above with a certain degree of particularity, or with reference to one or more individual embodiments, those skilled in the art could make numerous alterations to the disclosed embodiments without departing from the spirit or scope of the claimed invention. The use of the terms “about”, “approximately” or “substantially” means that a value of an element has a parameter that is expected to be close to a stated value or position. However, as is well known in the art, there may be minor variations that prevent the values from being exactly as stated. Accordingly, anticipated variances, such as 10% differences, are reasonable variances that a person having ordinary skill in the art would expect and know are acceptable relative to a stated or ideal goal for one or more embodiments of the present disclosure. It is also to be appreciated that the terms “top” and “bottom”, “left” and “right”, “up” or “down”, “first”, “second”, “before”, “after”, and other similar terms are used for description and ease of reference purposes only and are not intended to be limiting to any orientation or configuration of any elements or sequences of operations for the various embodiments of the present disclosure.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. An inductive sensor system comprising:
a circuit board that comprises coil sets, the coil sets comprising:
a first transmitter coil set comprising a first main transmitter coil and a first transmitter bias coil;
a first receiver coil set comprising a first main receiver coil and a first receiver bias coil;
a second transmitter coil set comprising a second main transmitter coil and a second transmitter bias coil; and
a second receiver coil set comprising a second main receiver coil and a second receiver bias coil,
wherein the circuit board further comprises:
a first electronic control unit (ECU) associated with the first transmitter coil set and the first receiver coil set; and
a second ECU that is separate from the first ECU, the second ECU being associated with the second transmitter coil set and the second receiver coil set.

2. The inductive sensor system of claim 1, wherein the coil sets are circularly wound coils.

3. The inductive sensor system of claim 1, further comprising:
an upper rotor comprising an upper target having a first metallic pattern; and
a lower rotor comprising a lower target having a second metallic pattern,
wherein the first main transmitter coil is positioned radially between an outer diameter and an inner diameter of both of the upper target and lower target.

4. The inductive sensor system of claim 3, wherein the second main transmitter coil is positioned radially between the outer diameter and the inner diameter of the upper target and the lower target.

5. The inductive sensor system of claim 4, wherein the first transmitter bias coil, the first receiver coil set, the second transmitter bias coil, and the second receiver coil set are positioned radially outside of the outer diameter of both of the upper target and the lower target.

6. The inductive sensor system of claim 4, wherein the first transmitter bias coil and the first receiver coil set are positioned radially inside of the inner diameter of both of the upper target and the lower target while the second transmitter bias coil and the second receiver coil set are positioned radially outside of the outer diameter of both of the upper target and the lower target.

7. The inductive sensor system of claim 4, wherein the first transmitter bias coil and the first receiver coil set are positioned radially outside of the outer diameter of both of the upper target and the lower target while the second transmitter bias coil and the second receiver coil set are positioned radially inside of the inner diameter of both of the upper target and the lower target.

8. The inductive sensor system of claim 4, wherein the first transmitter bias coil, the first receiver coil set, the second transmitter bias coil, and the second receiver coil set are positioned radially inside of the inner diameter of both of the upper target and the lower target.

9. The inductive sensor system of claim 1, wherein the first transmitter coil set is configured as a single coil comprising a first portion as the first main transmitter coil and a second portion as the first transmitter bias coil.

10. The inductive sensor system of claim 1, wherein the first transmitter coil set comprises a first coil as the first main transmitter coil that is separate from a second coil as the first transmitter bias coil, the first coil being electrically connected to the second coil.

11. The inductive sensor system of claim 1, wherein each of the coil sets comprises a single coil comprising at least two portions that respectively make up a main portion and a bias portion of the single coil.

12. The inductive sensor system of claim 1, wherein each of the coil sets comprises at least two separate coils that are connected to one another, and each of the at least two separate coils being a main portion and a bias portion, respectively, of each of the coil sets.

13. The inductive sensor system of claim 1, wherein at least one of the first transmitter coil set or the second transmitter coil set further comprises a compensation coil.

14. The inductive sensor system of claim 13, wherein
the compensation coil is radially positioned proximate to a main coil of the first transmitter coil set or the second transmitter coil set to which the compensation coil belongs, and
the main coil of the first transmitter coil set or the second transmitter coil set to which the compensation coil belongs is the first main transmitter coil or the second main transmitter coil, respectively.

15. The inductive sensor system of claim 14, wherein the compensation coil and the main coil of the first transmitter coil set or the second transmitter coil set to which the compensation coil belongs are arranged such that a first current flow within the compensation coil is in a direction opposite to a second current flow within the main coil.

16. The inductive sensor system of claim 15, wherein
the compensation coil and a bias coil of the first transmitter coil set or the second transmitter coil set to which the compensation coil belongs are arranged such that the first current flow within the compensation coil is in the direction opposite to third current flow within the bias coil,
the bias coil of the first transmitter coil set or the second transmitter coil set to which the compensation coil belongs is the first transmitter bias coil or the second transmitter bias coil, respectively, and
the bias coil and the main coil of the first transmitter coil set or the second transmitter coil set to which the compensation coil belongs are arranged such that the third current flow is in a same direction as the second current flow.

17. The inductive sensor system of claim 16, wherein for the first transmitter coil set or the second transmitter coil set to which the compensation coil belongs:
the compensation coil, the main coil, and the bias coil are formed as separate portions of a single coil.

18. The inductive sensor system of claim 16, wherein for the first transmitter coil set or the second transmitter coil set to which the compensation coil belongs:
the compensation coil, the main coil, and the bias coil are formed as separate coils.

19. The inductive sensor system of claim 14, wherein
the compensation coil of the first transmitter coil set comprises a first diameter that is smaller than a second diameter of the first main transmitter coil,
the first transmitter bias coil comprises a third diameter larger than the second diameter, and
the compensation coil of the first transmitter coil set is radially positioned within at least 2 mm of the first main transmitter coil while the first main transmitter coil is radially positioned within at least 5 mm of the first transmitter bias coil.

20. An inductive sensor system comprising:
a circuit board that comprises a redundant coil set structure configured to reduce mutual coupling between coils making up the redundant coil set structure, the redundant coil set structure comprises:
a first transmitter coil set, a first receiver coil set, a second transmitter coil set, and a second receiver coil set that each comprises at least two coils,
wherein the circuit board further comprises:
a first electronic control unit (ECU) associated with the first transmitter coil set and the first receiver coil set; and
a second ECU that is separate from the first ECU, the second ECU being associated with the second transmitter coil set and the second receiver coil set.
